(19) United States
(12) Patent Application Publication
(10) Pub. No.: US 2017/0131808 A1
(43) Pub. Date: May 11, 2017

(54) ANTENNA CONNECTING DEVICE AND TOUCH PANEL USING SAME

(71) Applicant: JTOUCH Corporation, Taoyuan City (TW)

(72) Inventors: Yu-Chou Yeh, Taoyuan City (TW); Yu-Hong Yen, Taoyuan City (TW); Chiu-Cheng Tsui, Taoyuan City (TW); Chia-So Chuang, Taoyuan City (TW)

(21) Appl. No.: 15/068,171

(22) Filed: Mar. 11, 2016

(30) Foreign Application Priority Data
Nov. 5, 2015 (TW) 104136445

(51) Int. Cl. G06F 3/044

(52) U.S. Cl. CPC G06F 3/044; G06F 2203/04111; G06F 2203/04112

(57) ABSTRACT

An antenna connecting device is provided and configured to electrically connect a touch panel having an antenna module to a communication cable. The antenna module has a feeding terminal and a ground terminal. The communication cable has a feeding wire and a ground wire. The antenna connecting device includes an insulating substrate, a first conductive set and a second conductive set. The first conductive set is disposed on the surface of the insulating substrate, and electrically connected and adhered with the feeding terminal of the antenna module and the feeding wire of the communication cable. The second conductive set is disposed on the surface of the insulating substrate, and electrically connected and adhered with the ground terminal of the antenna module and the ground wire of the communication cable. The first conductive set and the second conductive set are insulated from each other.

### FIELD OF THE INVENTION

The present invention relates to a connecting device and a touch panel using the same, and more particularly to an antenna connecting device and a touch panel having an antenna module and using the same.

### BACKGROUND OF THE INVENTION

Nowadays, touch control technologies are widely applied to the touch display devices of various electronic products in order to facilitate the users to control the operations of the electronic products. Generally, electronic devices with touch function includes a touch module and a display module. The touch panel includes a substrate, a plurality of sensing electrodes and a plurality of metal traces. The substrate is divided into a visible touch zone and a periphery wiring zone. The plurality of sensing electrodes are disposed on the substrate and located in the visible touch zone. The plurality of metal traces are disposed on the substrate, located in the periphery wiring zone, and electrically connected to the corresponding sensing electrodes. The touch panel and the display module are adhered to each other, so as to form the touch display devices of various electronic products.

On the other hand, with the advancement of information and communication technology, electronic devices with communicating functionality for example mobile phone, tablet or portable computer have become indispensable parts within people's daily life. Generally, electronic devices with wireless communicating function include an antenna module and a wireless signal processing module. The antenna module is configured as wireless signal transceiver, and usually disposed on a printed circuit board of the electronic device, an inner surface of case or back cover, or the bottom of the display panel by means of attachment. However, the electronic devices are tending towards the compact and high-density development. The conventional antenna modules and the dispositions thereof occupy a lot of inner space of the electronic devices, the circuit layout is influenced and the entire thickness of the electronic devices can't be reduced. For example, in a touch display apparatus with wireless communicating functionality, when the conventional antenna modules and the dispositions thereof are introduced into the touch display apparatus, the manufacturing steps and the entire cost will be increased, and likely cause signal interference and influence the wireless communicating functionality of the antenna module and the touch functionality of the touch module. Therefore, a touch panel formed by a structure of a touch sensing module with an integrated antenna is considered as an important developing direction.

The above described touch sensing module with an integrated antenna includes a metal mesh sensing electrode and a thin antenna disposed on a transparent substrate, and the thin antenna is electrically connected to an external communication cable by means of welding. Since the transparent substrate is made of polymer material, the heat-resistance temperature of the touch sensing module is limited at a range from 200° C. to 250° C. When the touch sensing module with the integrated antenna is electrically connected to the external communication cable by means of welding, the welding operation is usually performed at a high temperature ranged from 200° C. to 400° C. If the welding operation is performed overtime or the operation temperature of welding is too high, the touch sensing module with the integrated antenna will be damaged due to that the transparent substrate fails to bear the high operation temperature welding. Therefore, there is a need of providing an antenna connecting device for electrically connecting an external communication cable to an antenna module disposed on a transparent substrate without damaging the substrate, so as to overcome the above drawbacks.

### SUMMARY OF THE INVENTION

The present invention provides an antenna connecting device and a touch panel having an antenna module and using the same. The antenna connecting device is configured as a conductive film for electrically connecting the antenna module of the touch panel to an external communication cable. The electrical connection and fixing process can be simplified and performed easily, instead of connecting by welding at a high operation temperature. The transparent substrate won't be damaged during a connection and adhering process, and the yield thereof can be increased.

The present invention further provides an antenna connecting device and a touch panel having an antenna module and using the same. The antenna connecting device can electrically connect an antenna module of a touch panel to an external communication cable. The antenna connecting device has different conductive adhesive materials capable of connecting the antenna module of the touch panel to the external communication cable at different temperature ranges. Consequently, the electrical connection between the antenna module of the touch panel and the external communication cable can be achieved by means of low-temperature welding, ultra-violet curing, or hot-pressure solidifying.

The present invention further provides an antenna connecting device and a touch panel having an antenna module and using the same. The antenna connecting device can be designed according to the dispositions of an external communication cable and an antenna module of a touch panel, and the electrical connection between the communication cable and the antenna module can be achieved by the antenna connecting device without introducing the communication cable into the touch panel and increasing the entire thickness, so as to accomplish the requests of the narrow frame design or even the frameless design.

In accordance with an aspect of the present invention, there is provided an antenna connecting device. The antenna connecting device is configured to electrically connect a touch panel having an antenna module to a communication cable. The antenna module has a feeding terminal and a ground terminal. The communication cable has a feeding wire and a ground wire. The antenna connecting device includes at least an insulating substrate, a first conductive set and a second conductive set. The insulating substrate has at least a surface. The first conductive set is disposed on the surface of the insulating substrate, and electrically connected and adhered with the feeding terminal of the antenna module and the feeding wire of the communication cable. The second conductive set is disposed on the surface of the insulating substrate, and electrically connected and adhered with the ground terminal of the antenna module and the ground wire of the communication cable. The first conductive set and the second conductive set are insulated from each other.

In accordance with another aspect of the present invention, there is provided a touch panel. The touch panel include a transparent substrate, a metal mesh sensing circuit, an antenna module, a communication cable, and an antenna connecting device. The metal mesh sensing circuit is disposed on the transparent substrate and configured to form a visible touch zone. The antenna module is disposed on the transparent substrate and has an antenna radiator, a feeding terminal and a ground terminal. The communication cable has a feeding wire and a ground wire. The antenna connecting device includes at least one insulating substrate, a first conductive set and a second conductive set. The insulating substrate has at least a surface. The first conductive set is disposed on the surface of the insulating substrate, and electrically connected and adhered with the feeding terminal of the antenna module and the feeding wire of the communication cable. The second conductive set is disposed on the surface of the insulating substrate, and electrically connected and adhered with the ground terminal of the antenna module and the ground wire of the communication cable. The first conductive set and the second conductive set are insulated from each other.

The above contents of the present invention will become more readily apparent to those ordinarily skilled in the art after reviewing the following detailed description and accompanying drawings, in which:

### BRIEF DESCRIPTION OF THE DRAWINGS

FIG. 1A illustrates the structure of a touch panel having an antenna module according to a first embodiment of the present invention;

FIG. 1B illustrates the communication cable of FIG. 1A;

FIG. 2A is a cross sectional view illustrating an exemplary structure of an antenna connecting device for electrically connecting the communication cable to the antenna module of FIG. 1A and taken along the AA line;

FIG. 2B is a cross sectional view illustrating another exemplary structure of an antenna connecting device for electrically connecting the communication cable to the antenna module of FIG. 1A and taken along the AA line;

FIG. 3 illustrates the structure of a touch panel having an antenna module according to a second embodiment of the present invention;

FIG. 4 is a cross sectional view illustrating an exemplary structure of an antenna connecting device for electrically connecting the communication cable to the antenna module of FIG. 3 and taken along the AA line;

FIG. 5A is a cross sectional view illustrating another exemplary structure of an antenna connecting device for electrically connecting the communication cable to the antenna module of FIG. 3 and taken along the AA line;

FIG. 5B is a cross sectional view illustrating an exemplary structure of electrically connecting the communication cable and the antenna module by using the antenna connecting device of FIG. 5A;

FIG. 5C is a cross sectional view illustrating another exemplary structure of electrically connecting the communication cable and the antenna module by using the antenna connecting device of FIG. 5A;

FIG. 6A illustrates the structure of a touch panel having an antenna module capable of being connected with a communication cable by an antenna connecting device according to a third embodiment of the present invention; and

FIG. 6B is a cross sectional view illustrating an exemplary structure of electrically connecting the communication cable and the antenna module by using the antenna connecting device of FIG. 6A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

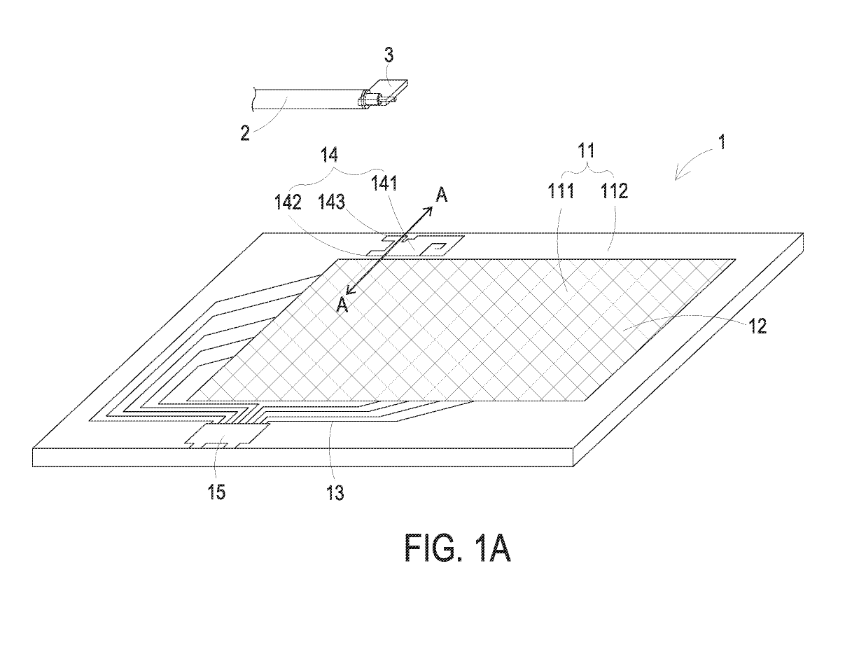

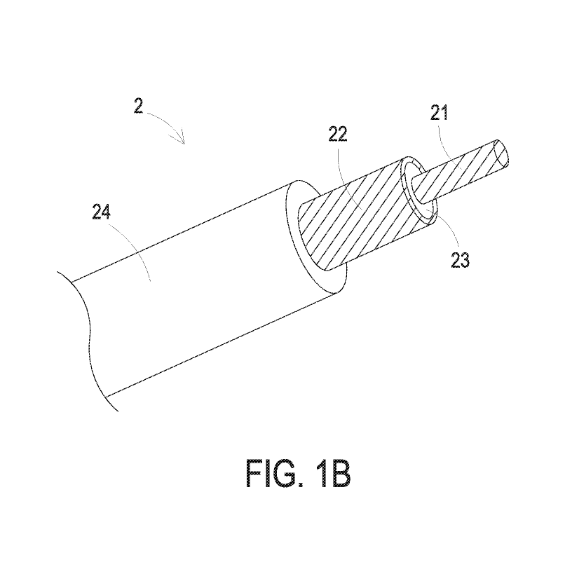

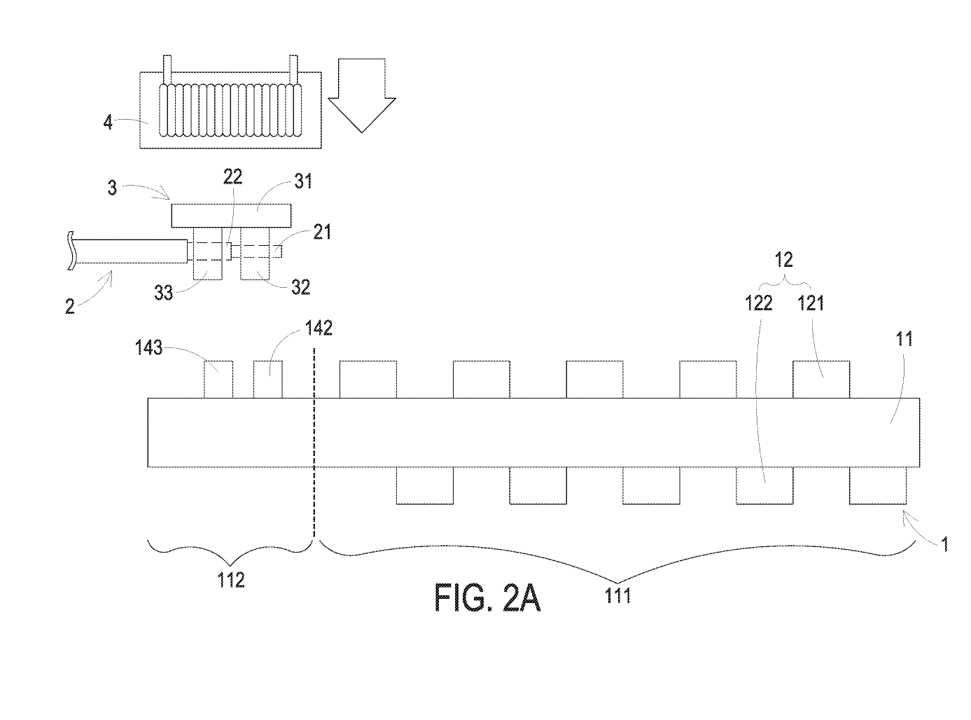

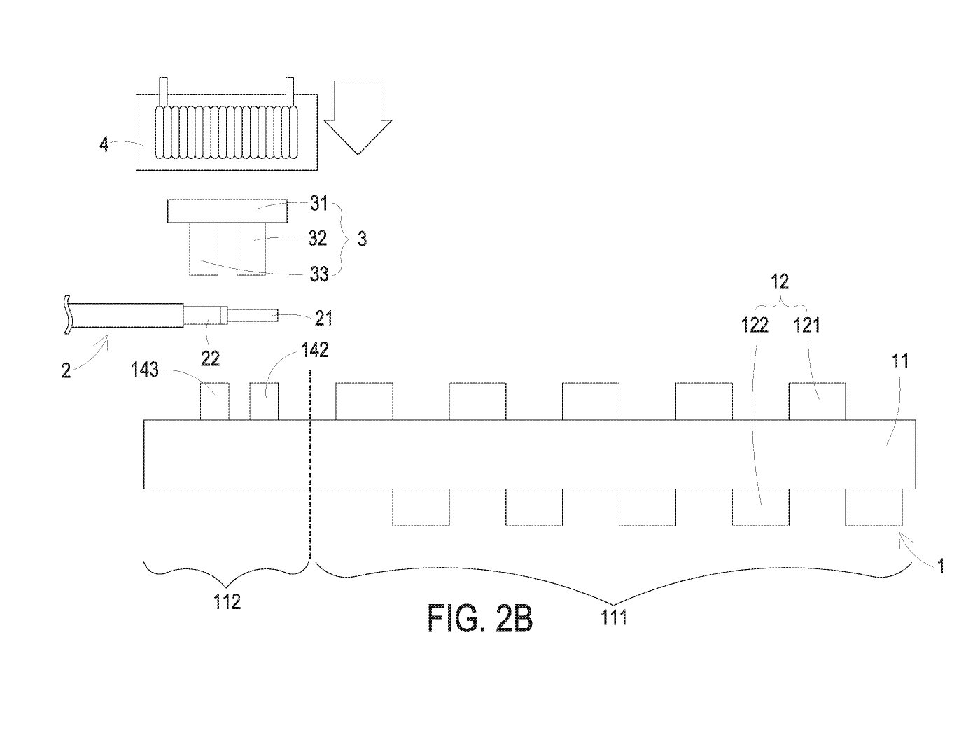

FIG. 1A illustrates the structure of a touch panel having an antenna module according to a first embodiment of the present invention. FIG. 1B illustrates the communication cable of FIG. 1A. FIG. 2A is a cross sectional view illustrating an exemplary structure of an antenna connecting device for electrically connecting the communication cable to the antenna module of FIG. 1A and taken along the AA line. As shown in FIGS. 1A, 1B and 2A, the touch panel 1 includes at least a transparent substrate 11, a metal mesh sensing circuit 12, plural metal traces 13, an antenna module 14, a communication cable 2 and an antenna connecting device 3. The metal mesh sensing circuit 12 includes a first sensing electrode 121 and a second sensing electrode 122 disposed on the top surface and bottom surface of the transparent substrate 11 respectively and configured to form a visible touch zone 111. Plural metal traces 13 are disposed on the top surface and bottom surface of the transparent substrate 11, configured to form a periphery wiring zone 112 around the visible touch zone 111, and electrically connected between the metal mesh sensing circuit 12 and a connecting cable 15. The antenna module 14 includes an antenna radiator 141, a feeding terminal 142, and a ground terminal 143. The antenna radiator 141 is configured to transmit and receive wireless signals. The feeding terminal 142 and the ground terminal 143 are connected with the antenna radiator 141. The communication cable 2 includes a feeding wire 21 and a ground wire 22 corresponding to the feeding terminal 142 and the ground terminal 143 of the antenna module 14, respectively. The antenna connecting device 3 is configured as a conductive adhesive film, and includes at least one insulating substrate 31, a first conductive set 32 and a second conductive set 33. The first conductive set 32 and the second conductive set 33 are disposed on the at least one surface of the insulating substrate 31, insulated from each other, and configured to electrically connect the feeding terminal 142 and the ground terminal 143 of the antenna module 14 to the feeding wire 21 and the ground wire 22 of the communication cable 2, respectively. In the embodiment, the first conductive set 32 and the second conductive set 33 are formed by but not limited to a conductive adhesive, a hot-pressure conductive block, a welding solder paste, a silver paste, or other conductive adhesive materials, and performed to adhere and solidify at an operating temperature perfectly ranged from 80° C. to 250° C.

The communication cable 2 further includes an insulating layer 23 and an outer covering layer 24. The insulating layer 23 covers the feeding wire 21, disposed between the feeding wire 21 and the ground wire 22, and partially exposed the feeding wire 21. The ground wire 22 covers the insulating layer 23. The outer covering layer 24 covers the ground wire 22 and is partially exposed the ground wire 22. It is noted that the structure of the communication cable 2 is not limited to the above embodiment, and can be adjusted according to the practical requirement. In the embodiment, the feeding wire 21 and the ground wire 22 of the communication cable 2 are jointed to the first conductive set 32 and the second conductive set 33 of the antenna connecting device 3 in advance. Then, a hot-pressure-solidifying process is performed by a high-temperature hot-pressure plate 4, and the first conductive set 32 and the second conductive set 33 of the antenna connecting device 3 are solidified and adhered to the feeding terminal 142 and the ground terminal 143 of the antenna module 14, so as to electrically connect the feeding terminal 142 of the antenna module 14 to the feeding wire 21 of the communication cable 2 and electrically connect the ground terminal 143 of the antenna module 14 to the ground wire 22 of the communication cable 2. It is noted that the first conductive set 32 and the second conductive set 33 of the antenna connecting device 3 can be solidified and adhered by means of but not limited to hot-pressure-solidifying, low-temperature solidifying, physical joining, chemical curing or ultra-violet curing.

FIG. 2B is a cross sectional view illustrating another exemplary structure of an antenna connecting device for electrically connecting the communication cable to the antenna module of FIG. 1A and taken along the AA line. In the embodiment, the feeding wire 21 and the ground wire 22 of the communication cable 2 are disposed on the feeding terminal 142 and the ground terminal 143 of the antenna module 14 respectively in advance, and the first conductive set 32 and the second conductive set 33 of the antenna connecting device 3 are disposed on the feeding wire 21 and the ground wire 22 of the communication cable 2, respectively. Then, a high-temperature hot-pressure plate 4 is moved from up to down for performing a hot-pressure solidifying process, so that the first conductive set 32 and the second conductive set 33 of the antenna connecting device 3 are solidified and adhered to the feeding terminal 142 and the ground terminal 143 of the antenna module 14, respectively. Consequently, the feeding terminal 142 of the antenna module 14 is electrically connected to the feeding wire 21 of the communication cable 2, and the ground terminal 143 of the antenna module 14 is electrically connected to the ground wire 22. In the embodiment, the transparent substrate 11 of the touch panel 1 is made by but not limited to polyethylene terephthalate (PET), polyetherimide (PEI), polyphenylensulfone (PPSU), polyimide (PI), polyethylene naphthalate (PEN), cyclic olefin copolymer (COC), liquid crystal polymer (LCP) or the mixtures thereof, and has a heat-resistance temperature ranged from 200° C. to 250° C. Therefore, the transparent substrate 11 of the touch panel 1 won't be damaged while the communication cable 2 and the antenna module 14 are connected and adhered by the antenna connecting device 3 in a solidifying and adhering process.

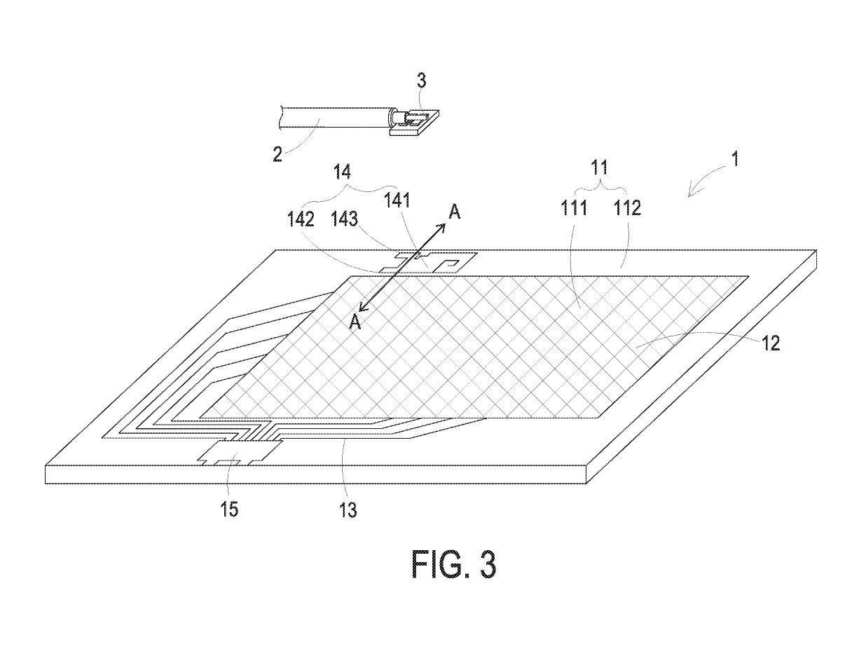

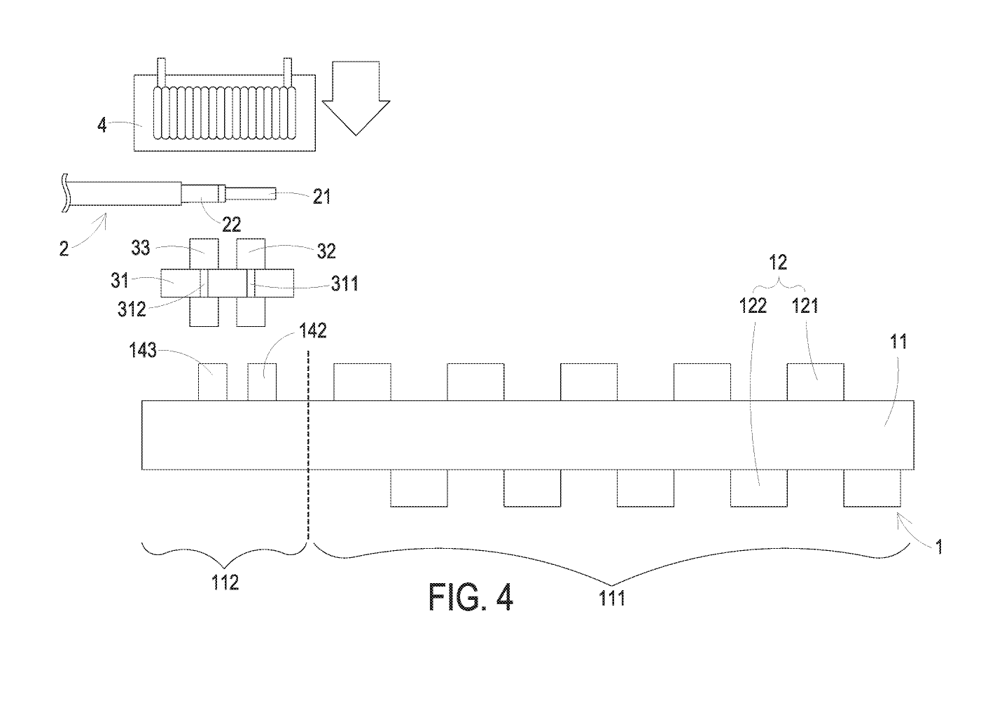

FIG. 3 illustrates the structure of a touch panel having an antenna module according to a second embodiment of the present invention. FIG. 4 is a cross sectional view illustrating an exemplary structure of an antenna connecting device for electrically connecting the communication cable to the antenna module of FIG. 3 and taken along the AA line. As shown in FIGS. 3 and 4, the structures, elements and functions of the touch panel 1 are similar to those of FIGS. 1A, 1B and 2A, and are not redundantly described herein. Comparing with the embodiment of FIGS. 1A, 1B and 2A, the antenna connecting device 3 includes an insulating substrate 31, a first conductive set 32 and a second conductive set 33. The insulating substrate 31 further includes a first through hole 311 and a second through hole 312. The first conductive set 32 passes through the first through hole 311 and disposed on the top surface and bottom surface of the insulating substrate 31. Namely, a portion of the first conductive set 32 is disposed on the top surface of the insulating substrate 31, and the other portion of the first conductive set 32 is disposed on the bottom surface of the insulating substrate 31. The second conductive set 33 passes through the second through hole 312 and disposed on the top surface and bottom surface of the insulating substrate 31. Namely, a portion of the second conductive set 33 is disposed on the top surface of the insulating substrate 31, and the other portion of the second conductive set 33 is disposed on the bottom surface of the insulating substrate 31. The first through hole 311 and the second through hole 312 aren't in communication with each other, and the first conductive set 32 and the second conductive set 33 are insulated from each other. When a solidifying and adhering process is performed, the feeding wire 21 and the ground wire 22 of the communication cable 2 are respectively electrically connected to the first conductive set 32 and the second conductive set 33 and disposed on the top surface of the insulating substrate 31. The feeding terminal 142 and the ground terminal 143 of the antenna module 14 are respectively electrically connected to the first conductive set 32 and the second conductive set 33 and disposed on the bottom surface of the insulating substrate 31. The solidifying and adhering process is accomplished by mean of moving a high-temperature hot-pressure plate 4 from up to down. Thus, the feeding terminal 142 of the antenna module 14 is electrically connected to the feeding wire 21 of the communication cable 2, and the ground terminal 143 of the antenna module 14 is electrically connected to the ground wire 22 of the communication cable 2.

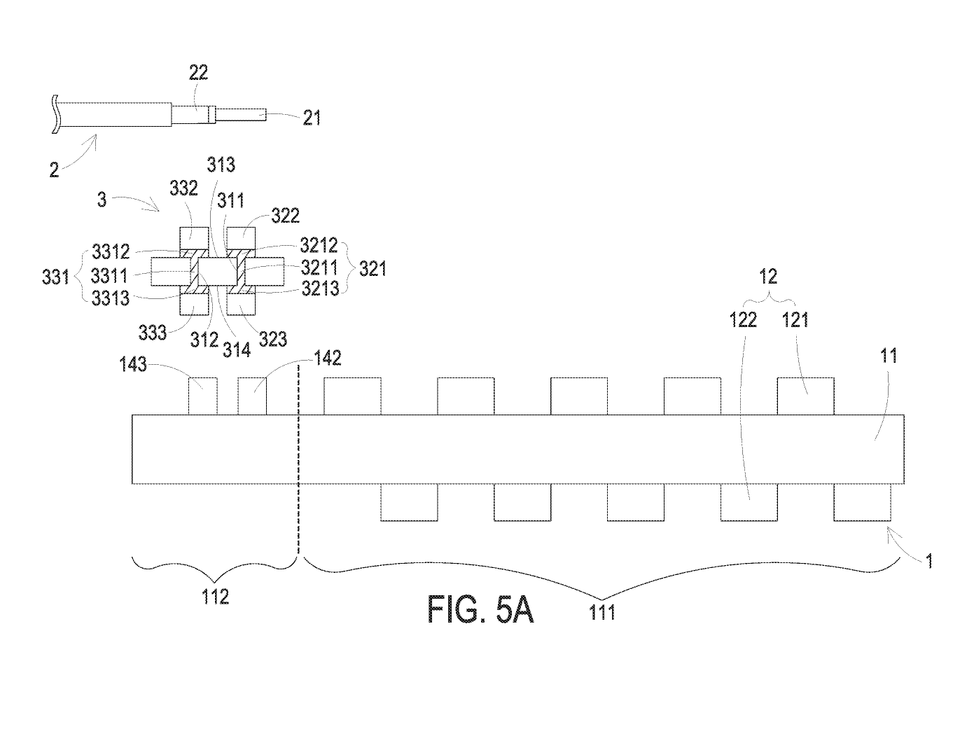

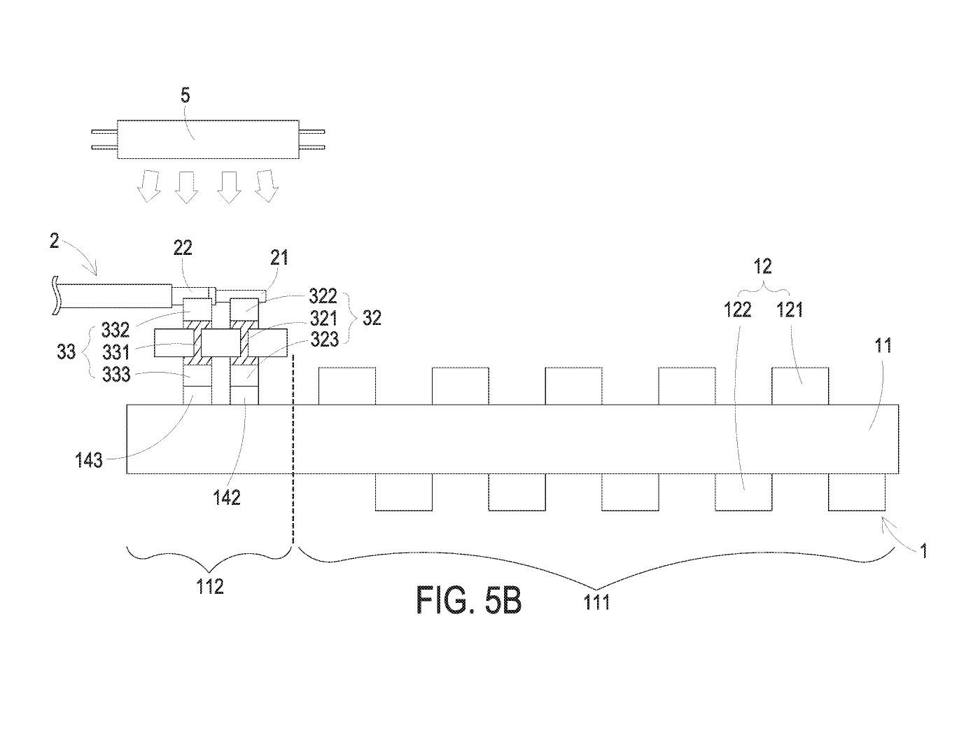

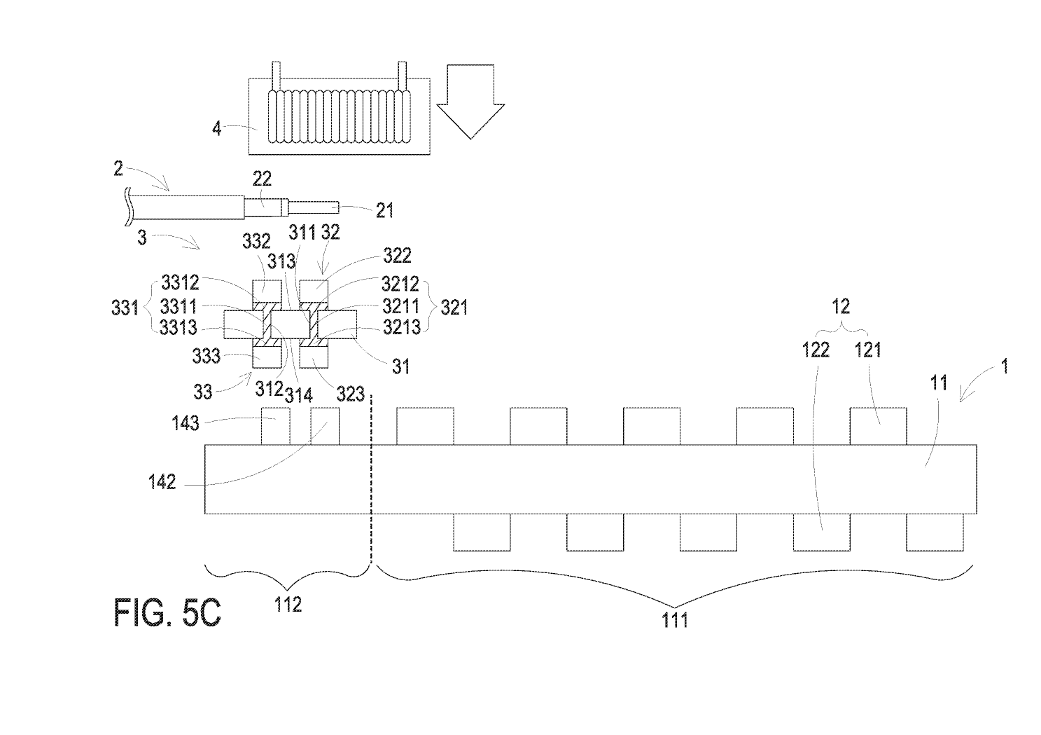

FIG. 5A is a cross sectional view illustrating another exemplary structure of an antenna connecting device for electrically connecting the communication cable to the antenna module of FIG. 3 and taken along the AA line. As shown in FIGS. 3 and 5A, the structures, elements and functions of the touch panel 1 are similar to those of FIG. 4, and are not redundantly described herein. Comparing with the embodiment of FIG. 4, the antenna connecting device 3 includes an insulating substrate 31, a first conductive set 32 and a second conductive set 33. The insulating substrate 31 further includes a first through hole 311 and a second through hole 312. The first conductive set 32 includes a first metal pillar 321, a first conductive adhesive element 322, and a second conductive adhesive element 323. The first metal pillar 321 has a first upper pad 3212, a first connecting part 3211 and a first lower pad 3213, and the first upper pad 3212, the first connecting part 3211 and the first lower pad 3213 are integrally formed in one piece. Similarly, the second conductive set 33 includes a second metal pillar 331, a third conductive adhesive element 332, and a fourth conductive adhesive element 333. The second metal pillar 331 has a second upper pad 3312, a second connecting part 3311, and a second lower pad 3313, and the second upper pad 3312, the second connecting part 3311 and the second lower pad 3313 are integrally formed in one piece.

In the embodiment, the first conductive set 32 is disposed on the top surface and bottom surface of the insulating substrate 31 via the first metal pillar 321, and the second conductive set 33 is disposed on the top surface and bottom surface of the insulating substrate 31 via the second metal pillar 331. In the detailed description, the first connecting part 3211 is embedded in the first through hole 311, the first upper pad 3212 is disposed on the top surface 313 of the insulating substrate 31, and the first lower pad 3213 is disposed on the bottom surface 314 of the insulating substrate 31. The first conductive adhesive element 322 and the second conductive adhesive element 323 are disposed on the first upper pad 3212 and the first lower pad 3213 respectively. The second connecting part 3311 is embedded in the second through hole 312, the second upper pad 3312 is disposed on the top surface of the insulating substrate 31, and the second lower pad 3313 is disposed on the bottom surface 314 of the insulating substrate 31. The third conductive adhesive element 332 and the fourth conductive adhesive element 333 are disposed on the second upper pad 3312 and second lower pad 3313 respectively. FIG. 5B is a cross sectional view illustrating an exemplary structure of electrically connecting the communication cable and the antenna module by using the antenna connecting device of FIG. 5A. The first conductive adhesive element 322 and the second conductive adhesive element 323 of the first conductive set 32 and the third conductive adhesive element 332 and the fourth conductive adhesive element 333 of the second conductive set 33 are formed by the same material or element, for example but not limited to a conductive adhesive. When a solidifying and adhering process is performed, the feeding wire 21 and the ground wire 22 of the communication cable 2 are respectively corresponding to and electrically connected with the first conductive adhesive element 322 of the first conductive set 32 and the third conductive adhesive element 332 of the second conductive set 33 on the top surface of the insulating substrate 31. The feeding terminal 142 and the ground terminal 143 of the antenna module 14 are respectively corresponding to and electrically connected with the second conductive adhesive element 323 of the first conductive set 32 and the fourth conductive element 333 of the second conductive set 33 on the bottom surface of the insulating substrate 31. When an ultra-violet lamp 5 is provided for performing ultra-violet curing upon the conductive adhesive elements, the first conductive adhesive element 322 and the second conductive adhesive element 323 of the first conductive set 32 are solidified, and the third conductive adhesive element 332 and the fourth conductive adhesive element 333 of the second conductive set 33 are solidified, as so to adhere the communication cable 2 to the top surface of the insulating substrate 31, and adhere the bottom surface of the insulating substrate 31 to the antenna module 14. Consequently, the feeding terminal 142 of the antenna module 14 is electrically connected to the feeding wire 21 of the communication cable 2, and the ground terminal 143 of the antenna module 14 is electrically connected to the ground wire 22 of the communication cable 2. Comparing with the above embodiment, in the embodiment, the first conductive set 32 and the second conductive set 33 further include a first metal pillar 321 and a second metal pillar 331 respectively, so as to decrease the impedance of the first conductive set 32 and the second conductive set 33.

FIG. 5C is a cross sectional view illustrating another exemplary structure of electrically connecting the communication cable and the antenna module by using the antenna connecting device of FIG. 5A. As shown in FIGS. 3, 5A and 5C, the structures, elements and functions of the touch panel 1 are similar to those of FIGS. 5A and 5B, and are not redundantly described herein. Comparing with the embodiment of FIGS. 5A and 5B, the first conductive adhesive element 322 of the first conductive set 32 and the third conductive adhesive element 332 of the second conductive set 33 are formed by the same material or element. The second conductive adhesive element 323 of the first conductive 32 and the fourth conductive adhesive element 333 of the second conductive 33 are formed by the same material or element. In the embodiment, the first conductive adhesive element 322 of the first conductive set 32 and the third conductive adhesive element 332 of the second conductive set 33 are formed by but not limited to a conductive adhesive, a hot-pressure conductive block, a welding solder paste, a silver paste, or other high-temperature conductive adhesive materials, and performed to adhere and solidify at a high operating temperature perfectly ranged from 180° C. to 250° C. The second conductive adhesive element 323 of the first conductive set 32 and the fourth conductive adhesive element 333 of the second conductive set 33 are formed by but not limited to a conductive adhesive, a hot-pressure conductive block, a welding solder paste, a silver paste, or other low-temperature conductive adhesive materials, and performed to adhere and solidify at a high operating temperature perfectly ranged from 80° C. to 200° C. Because the first conductive adhesive element 322 and the third conductive adhesive element 332 are electrically connected to the communication cable 2 and the communication cable 2 has high temperature resistance, they can be formed by high-temperature adhesive materials. The second conductive adhesive element 323 and the fourth conductive adhesive 333 are electrically connected to the antenna module 14 disposed on the transparent substrate 11. If the solidifying and adhering process is performed at an overheating temperature, the transparent substrate 11 will be damaged. Hence, the second conductive adhesive element 323 and the fourth conductive adhesive 333 should be formed by low-temperature adhesive materials. Namely, the first conductive adhesive element 322 and the third conductive adhesive element 332 are formed by the materials having high temperature resistance and operated at an operating temperature higher than that of the second conductive adhesive element 323 and the fourth conductive adhesive element 333. In practice, when a high-temperature hot-pressure plate 4 is moved from up to down for performing a hot-pressure-solidifying process, the high temperature portion thereof is in contact with the communication cable 2 and a high-temperature solidifying and adhering process is performed to adhere the communication cable 2 with the antenna connecting device 3. Then, the heat is gradually transferred to the antenna module 14 and the transparent substrate 11, and the temperature is gradually decreased and suitable to perform a low-temperature solidifying and adhering process. Thus, the antenna connecting device 3 can connect and conduct the antenna module 14 disposed on the transparent substrate 11 to the communication cable 2 without damaging the structure of touch panel 1 due to the high-temperature solidifying and adhering process.

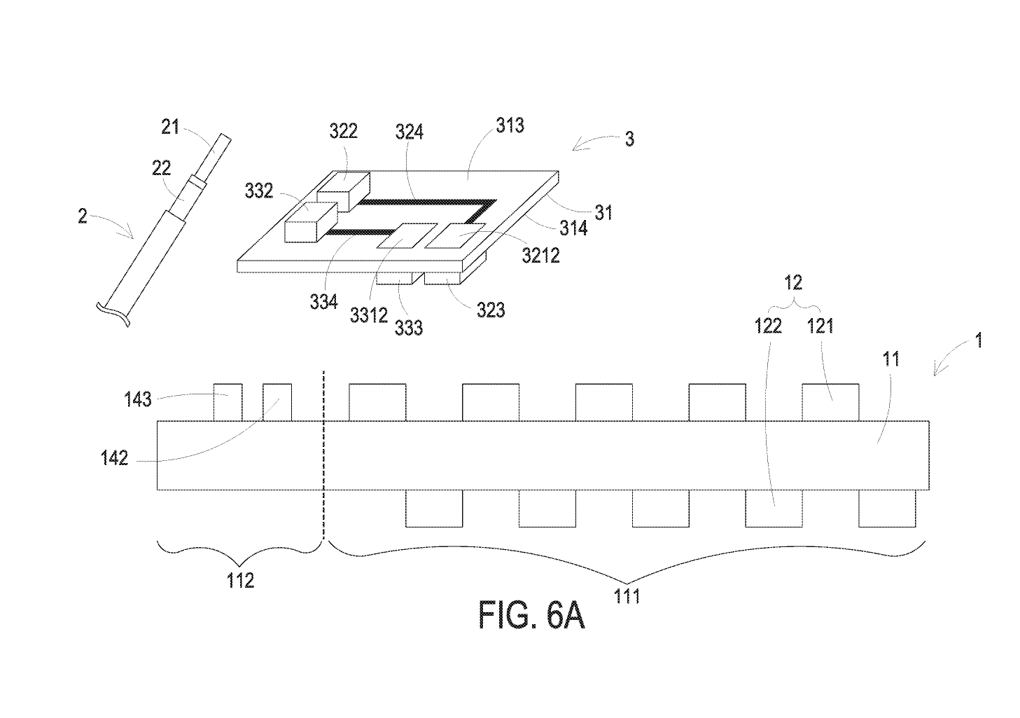

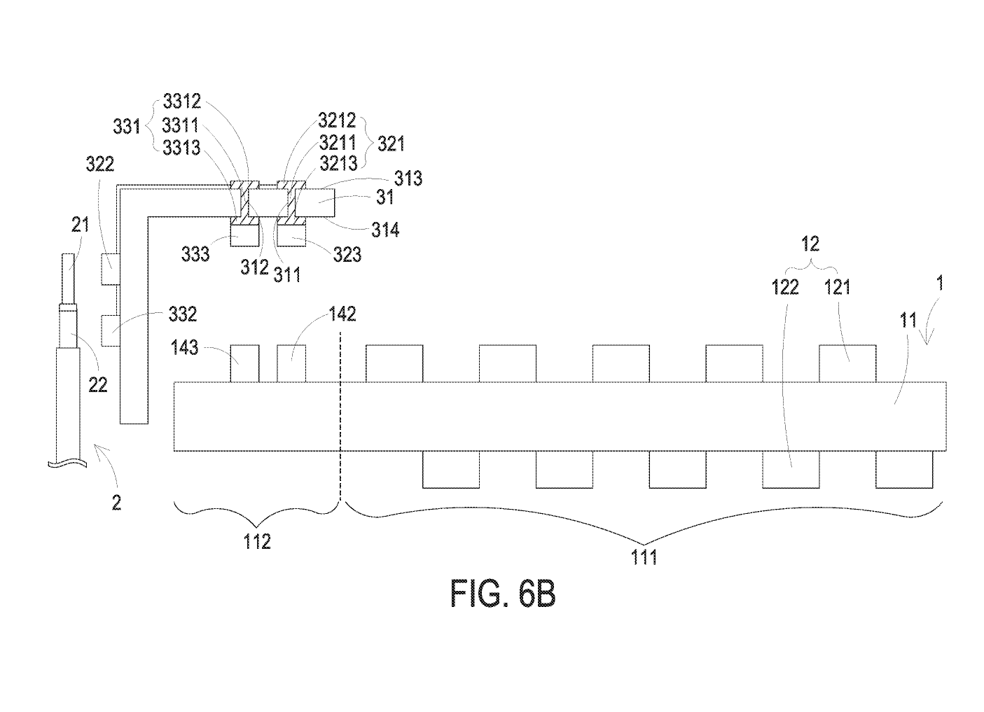

FIG. 6A illustrates the structure of a touch panel having an antenna module capable of being connected with a communication cable by an antenna connecting device according to a third embodiment of the present invention. FIG. 6B is a cross sectional view illustrating an exemplary structure of electrically connecting the communication cable and the antenna module by using the antenna connecting device of FIG. 6A. As shown in FIGS. 6A and 6B, the structures, elements and functions of the touch panel 1 are similar to those of FIG. 5A, and are not redundantly described herein. Comparing with the embodiment of FIG. 5A, the insulating substrate 31 of the antenna connecting device 3 is a foldable insulating substrate. The first conductive adhesive element 322 is not disposed on the top of the first upper pad 3212, and the third conductive adhesive element 332 is not disposed on the top of the second upper pad 3312. The first conductive set 32 further includes a first connecting trace 324, and the second conductive set 33 further includes a second connecting trace 334. The first connecting trace 324 is electrically connected between the first upper pad 3212 and the first conductive adhesive element 322. The second connecting trace 334 is electrically connected between the second upper pad 3312 and the third conductive adhesive element 332. Because the insulating substrate 31 of the antenna connecting device 3 is a foldable insulating substrate, the antenna connecting device 3 can be folded according to the requirement of spatial design, and accomplish the conduction of the feeding terminal 142 of the antenna module 14 to the feeding wire 21 of the communication cable 2 and the conduction of the ground terminal 143 of the antenna module 14 to the ground wire 22 of the communication cable 2.

Thus, the antenna connecting device 3 can connect and conduct the antenna module 14 of touch panel 1 to the communication cable 2 disposed on the lateral side of the touch panel 1, instead of introducing the communication cable and increasing the entire thickness, so as to accomplish the requests of the narrow frame design or even the frameless design.

In summary, the present invention provides an antenna connecting device and a touch panel having an antenna module and using the same. The antenna connecting device is configured as a conductive film for electrically connecting the antenna module of the touch panel to an external communication cable. The electrical connection and fixing process can be simplified and performed easily, instead of connecting by welding at a high operation temperature. The transparent substrate won't be damaged during a connection and adhering process, and the yield thereof can be increased. The antenna connecting device can have different conductive adhesive materials capable of connecting the antenna module of the touch panel to the external communication cable at different temperature ranges. Consequently, the electrical connection between the antenna module of the touch panel and the external communication cable can be achieved by means of low-temperature welding, ultra-violet curing, or hot-pressure solidifying. The antenna connecting device can be designed according to the dispositions of an external communication cable and an antenna module of a touch panel, and the electrical connection between the communication cable and the antenna module can be achieved by the antenna connecting device without introducing the communication cable into the touch panel and increasing the entire thickness, so as to accomplish the requests of the narrow frame design or even the frameless design.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna connecting device, configured to electrically connect a touch panel having an antenna module to a communication cable, wherein the antenna module has a feeding terminal and a ground terminal, and the communication cable has a feeding wire and a ground wire, the antenna connecting device comprising:
at least an insulating substrate having at least a surface;
a first conductive set, disposed on the surface of the insulating substrate, electrically connected and adhered with the feeding terminal of the antenna module and the feeding wire of the communication cable; and
a second conductive set, disposed on the surface of the insulating substrate, electrically connected and adhered with the ground terminal of the antenna module and the ground wire of the communication cable, wherein the first conductive set and the second conductive set are insulated from each other.

2. The antenna connecting device according to claim 1, wherein the touch panel comprises a transparent substrate and a metal mesh sensing circuit, wherein the metal mesh sensing circuit is disposed on the transparent substrate and configured to form a visible touch zone, and the antenna module is disposed on the transparent substrate.

3. The antenna connecting device according to claim 1, wherein the first conductive set and the second conductive set are disposed on the same surface of the insulating substrate.

4. The antenna connecting device according to claim 1, wherein the first conductive set and the second conductive set are formed by a conductive adhesive material, the conductive adhesive materials is selected from a group consisted of a conductive adhesive, a hot-pressure conductive block, a welding solder paste, and a silver paste, and performed to adhere and solidify at an operating temperature ranged from 80° C. to 250° C.

5. The antenna connecting device according to claim 1, wherein the insulating substrate comprises a first through hole and a second through hole, and the first conductive set and the second conductive set are disposed on a top surface and a bottom surface of the insulating substrate via the first through hole and the second through hole, respectively.

6. The antenna connecting device according to claim 1, wherein the insulating substrate comprises a first through hole and a second through hole, and the first conductive set comprises:
a first metal pillar having a first upper pad, a first connecting part and a first lower pad, wherein the first connecting part is embedded in the first through hole, the first upper pad is disposed on a top surface of the insulating substrate, and the first lower pad is disposed on a bottom surface of the insulating substrate;
a first conductive adhesive element electrically connected to the first upper pad and configured to conduct with the feeding wire of the communication cable; and
a second conductive adhesive element disposed on the first lower pad and configured to conduct with the feeding terminal of the antenna module.

7. The antenna connecting device according to claim 6, wherein the second conductive set comprises:
a second metal pillar having a second upper pad, a second connecting part and a second lower pad, wherein the second connecting part is embedded in the second through hole, the second upper pad is disposed on the top surface of the insulating substrate, and the second lower pad is disposed on the bottom surface of the insulating substrate;
a third conductive adhesive element electrically connected to the second upper pad and configured to conduct with the ground wire of the communication cable; and
a fourth conductive adhesive element disposed on the second lower pad and configured to conduct with the ground terminal of the antenna module.

8. The antenna connecting device according to claim 7, wherein the first conductive adhesive element and the third conductive adhesive element are formed by a conductive adhesive material performed to adhere and solidify at an operating temperature higher than that of the second conductive adhesive element and the fourth conductive adhesive element.

9. The antenna connecting device according to claim 7, wherein the first conductive set further comprises a first connecting trace electrically connected between the first upper pad and the first conductive adhesive element, and the second conductive set further comprises a second connecting trace electrically connected between the second upper pad and the third conductive adhesive element.

10. The antenna connecting device according to claim 1, wherein the insulating substrate is a foldable insulating substrate.

11. A touch panel, comprising
a transparent substrate;
a metal mesh sensing circuit disposed on the transparent substrate and configured to form a visible touch zone;
an antenna module disposed on the transparent substrate and having an antenna radiator, a feeding terminal and a ground terminal;
a communication cable having a feeding wire and a ground wire; and
an antenna connecting device comprising:
at least an insulating substrate having at least a surface;
a first conductive set, disposed on the surface of the insulating substrate, electrically connected and adhered with the feeding terminal of the antenna module and the feeding wire of the communication cable; and
a second conductive set, disposed on the surface of the insulating substrate, electrically connected and adhered with the ground terminal of the antenna module and the ground wire of the communication cable, wherein the first conductive set and the second conductive set are insulated from each other.

12. The touch panel according to claim 11, wherein the first conductive set and the second conductive set are disposed on the same surface of the insulating substrate.

13. The touch panel according to claim 11, wherein the first conductive set and the second conductive set are formed by a conductive adhesive material, the conductive adhesive materials is selected from a group consisted of a conductive adhesive, a hot-pressure conductive block, a welding solder paste, and a silver paste, and performed to adhere and solidify at an operating temperature ranged from 80° C. to 250° C.

14. The touch panel according to claim 11, wherein the insulating substrate comprises a first through hole and a second through hole, and the first conductive set and the second conductive set are disposed on a top surface and a bottom surface of the insulating substrate via the first through hole and the second through hole, respectively.

15. The touch panel according to claim 11, wherein the insulating substrate comprises a first through hole and a second through hole, and the first conductive set comprises:
a first metal pillar having a first upper pad, a first connecting part and a first lower pad, wherein the first connecting part is embedded in the first through hole, the first upper pad is disposed on a top surface of the insulating substrate, and the first lower pad is disposed on a bottom surface of the insulating substrate;
a first conductive adhesive element electrically connected to the first upper pad and configured to conduct with the feeding wire of the communication cable; and
a second conductive adhesive element disposed on the first lower pad and configured to conduct with the feeding terminal of the antenna module.

16. The touch panel according to claim 15, wherein the second conductive set comprises:
a second metal pillar having a second upper pad, a second connecting part and a second lower pad, wherein the second connecting part is embedded in the second through hole, the second upper pad is disposed on the top surface of the insulating substrate, and the second lower pad is disposed on the bottom surface of the insulating substrate;
a third conductive adhesive element electrically connected to the second upper pad and configured to conduct with the ground wire of the communication cable; and
a fourth conductive adhesive element disposed on the second lower pad and configured to conduct with the ground terminal of the antenna module.

17. The touch panel according to claim 16, wherein the first conductive adhesive element and the third conductive adhesive element are formed by a conductive adhesive material performed to adhere and cure at an operating temperature higher than that of the second conductive adhesive element and the fourth conductive adhesive element.

18. The touch panel according to claim 16, wherein the first conductive set further comprises a first connecting trace electrically connected between the first upper pad and the first conductive adhesive element, and the second conductive set further comprises a second connecting trace electrically connected between the second upper pad and the third conductive adhesive element.

19. The touch panel according to claim 11, wherein the insulating substrate is a foldable insulating substrate.
